(19) United States
(12) Patent Application Publication
(10) Pub. No.: US 2022/0380968 A1
(43) Pub. Date: Dec. 1, 2022

(54) AIR-FLOW STORAGE CASE

(71) Applicant: Ozhan Akcakaya, Alexandria, VA (US)

(72) Inventor: Ozhan Akcakaya, Alexandria, VA (US)

(21) Appl. No.: 17/330,918

(22) Filed: May 26, 2021

(51) Int. Cl. D06F 59/04; A45F 3/02; F26B 1/00

(52) U.S. Cl. CPC D06F 59/04; A45F 3/02; F26B 1/00; A45F 2003/003

(57) ABSTRACT

An enclosure for drying items worn by a user exercising includes a hollow case body having, a case top and a case bottom, a main mold form having perimeter dimensions conforming to the internal perimeter of the case body fitted or otherwise installed therein, the mold form including a pair of oblong pocket forms adapted to nest a pair of items and a pair of airflow devices electronically equipped to generate air circulation into the gloves through a tubular architecture, one airflow device strategically mounted within one pocket form. Items are placed over the airflow devices and urged to nest within the pocket forms in the main mold form, and wherein a switch connected to a battery and to the hollow case body or to the main mold form is manipulated by a user to power on the airflow devices to circulate air through the internal volume of the items.

### CROSS-REFERENCE TO RELATED DOCUMENTS

[NA]

### BACKGROUND OF THE INVENTION

### 1. Field of the Invention

The present invention is in the field of packaging apparatus and pertains particularly to methods and apparatus for storing and drying boxing gloves.

### 2. Discussion of the State of the Art

In the art of sports equipment, items that are worn often get wet from sweat of a user and bacteria growth may be a problem. Items including shoes, helmets, pads and gloves of various types, needs to be stored in a manner that allows the items to dry. Specifically, in contact martial arts, combatants often wear protective apparel or gear including padded gloves such as those used in the art of boxing. Boxing gloves are typically worn by the combatants throughout a match. Boxing gloves may be rated in the art of boxing by the level or amount of padding the glove has. The padding, typically horsehair or latex/polyvinyl chloride (PVC) may regulate the size of a pair of boxing gloves from 10-ounce gloves to up to 20-ounce gloves dependent on how much padding is provided to a glove.

A challenge in the art of boxing and other martial arts that employ padded gloves is that the padding material absorbs moisture and takes a long period to dry. Constantly damp boxing gloves can become moldy and can become a hot bed for breeding bacterium lending to foul odors and possible allergic or other skin reactions. Padded gloves should not be washed or immersed in water because of the padding and time it would take to dry the gloves. For those who use gloves continuously, replacement of the gloves frequently because of moldy or bacterium laden padding is an economic drawback.

Therefore, what is clearly needed is a storage apparatus or enclosure and an airflow generation system and method that will keep padded gloves dry.

### BRIEF SUMMARY OF THE INVENTION

According to an embodiment of the present invention, an enclosure for drying gloves is provided and includes a hollow case body having an internal volume, a case top closing one end, and a case bottom closing the other end of the hollow body, a main mold form having perimeter dimensions conforming to the internal perimeter of the hollow case body fitted or otherwise installed therein, the mold form including a pair of oblong pocket forms having sufficient internal volume to nest a pair of gloves, a pair of airflow devices electronically equipped to generate directional air circulation into and out through a tubular architecture, one airflow device strategically mounted within one pocket form wherein gloves are placed over the airflow devices and urged to nest within the pocket forms in the main mold form, and wherein a switch connected to a battery and to the hollow case body or to the main mold form is manipulated by a user to power on the airflow devices to circulate air through the internal volume of the gloves.

In one embodiment, the gloves are boxing gloves or gloves used in martial arts. In one embodiment, the case top and case bottom are pivot mounted to one side of the hollow case body and may be opened or closed. In another embodiment, the case top and case bottom are attachable to close off the hollow case body, and removable to open the hollow case body. In one embodiment, the oblong pocket forms are contiguous with the main mold form and arranged linearly and oriented vertically within the enclosure. In another embodiment, the oblong pocket forms are contiguous with the main mold form and arranged adjacently and oriented horizontally. In this embodiment, the oblong pocket forms retain the general shape of a boxing glove.

In a preferred embodiment, the airflow devices are manifolds electrically equipped to generate directional air circulation by a pair resident electric fans installed one each in the manifolds, the fans having electrical connection to the battery and the switch, the battery having a further electrical connection to a charging port mounted on the hollow case body or on the main mold form within the hollow case body. In a variation of this embodiment, the manifolds are rigidly attached to or are materially contiguous with the oblong pocket forms the manifolds and pocket forms oriented vertically within the enclosure, the manifolds each hosting a glove placed thereon, the glove nesting within the oblong pocket form. In another variant of the embodiment, the manifolds are separate components pivot-mounted to the oblong pocket forms, the manifolds urged to vertical position to accept the gloves and pivoted to horizontal to nest within the oblong pocket forms.

In one embodiment, the main mold form includes one or more strategically placed airflow slot patterns or patterns of openings enabling airflow through the main mold form and into the airflow devices. In an embodiment where the airflow devices are pivot mounted manifolds, the manifolds include a pair of opposing vent caps disposed at either side of the manifold body and oriented orthogonal to the longitudinal center of the manifold. In an embodiment where the airflow devices are manifolds, the manifolds include removable end caps threaded onto or pressed onto the free ends thereof.

In one embodiment including manifolds electrically adapted to circulate air, one or more airflow filters formed of a moisture absorbing material are provided in the path of air circulation. In a variation of this embodiment, the enclosure further includes a pair of heating elements disposed one per to the manifolds just above or below the electric fans. In another variation of the embodiment, the enclosure further includes a timer function connected to the switch.

According to one aspect of the present invention, a method for staging and drying a pair of gloves within an enclosure is provided, the enclosure including a hollow case body having a case top and a case bottom hosting a main mold form having perimeter dimensions conforming to the internal perimeter of the hollow case body, the mold form including a pair of oblong pocket forms each hosting an airflow device electronically equipped to generate air circulation, the method including steps (a) opening the case top to gain access to the main mold form, (b) place one glove over one airflow device nested within a host pocket form, (c) place the remaining glove over the remaining airflow device nested within the remaining pocket form, (d) engaging a switch to power on the airflow devices, and (e) optionally closing the case top.

In one aspect of the method, the airflow devices are manifolds equipped with electrical fans for circulating air. In a variant aspect of the method, a step is added after step (a) and before step (b) for urging horizontally positioned manifolds into a vertical position to accept the gloves placement there over, and wherein a step is added after (c) and before (d) for urging the manifolds hosting gloves back down into a horizontal position within the pocket forms. In this aspect of the method, the step added after (c) and before (d) is optional wherein if not implemented, step (e) cannot be implemented.

### BRIEF DESCRIPTION OF THE SEVERAL VIEWS OF THE DRAWINGS

FIG. 1A is a front elevation view of an airflow boxing glove case according to an embodiment of the present invention.

FIG. 1B is a side elevation view of the airflow boxing glove case of FIG. 1A.

FIG. 1C is a perspective view of the airflow boxing glove case of FIG. 1A.

FIG. 2A is an overhead perspective view of an airflow boxing glove case analogous to the boxing glove case of FIG. 1A depicting interior elements.

FIG. 2B is an underneath perspective view of the airflow boxing glove case of FIG. 2A.

FIG. 3A is a front elevation view of an airflow boxing glove case according to another embodiment of the present invention.

FIG. 3B is a perspective view of the airflow boxing glove case of FIG. 3A depicting interior elements.

FIG. 3C is an overhead perspective view of the airflow boxing glove case of FIG. 3A depicting interior elements.

FIG. 4 is a perspective view of an airflow device used in an airflow boxing glove case according to one embodiment of the invention.

FIG. 5A is a side elevation view of the airflow device of FIG. 4.

FIG. 5B is a top end view of the airflow device of FIG. 4.

FIG. 6A is a perspective view of an airflow device used in an airflow boxing glove case according to one embodiment of the invention.

FIG. 6B is a perspective view of the airflow device of FIG. 6A rotated to an opposing 180 degrees for reference.

### DETAILED DESCRIPTION OF THE INVENTION

In various embodiments described in enabling detail herein, the inventor provides a unique system for storing and drying padded gloves used in martial arts. It is a goal of the present invention to provide an enclosure within which sport items worn by a user are stored that may actively dry the insides of the items using a created airflow. In the embodiments, produced below, boxing gloves are used as the item being protected, but should not be viewed as limiting the invention. The case would work to protect and dry shoes, head gear, body pads, etc.

It is a further goal of the present invention to provide a drying method that may inhibit mold and bacterium from establishing within the padding of the boxing gloves, the drying method executed during a time between use of the boxing gloves. The present invention is described using the following examples, which may describe more than one relevant embodiment falling within the scope of the invention.

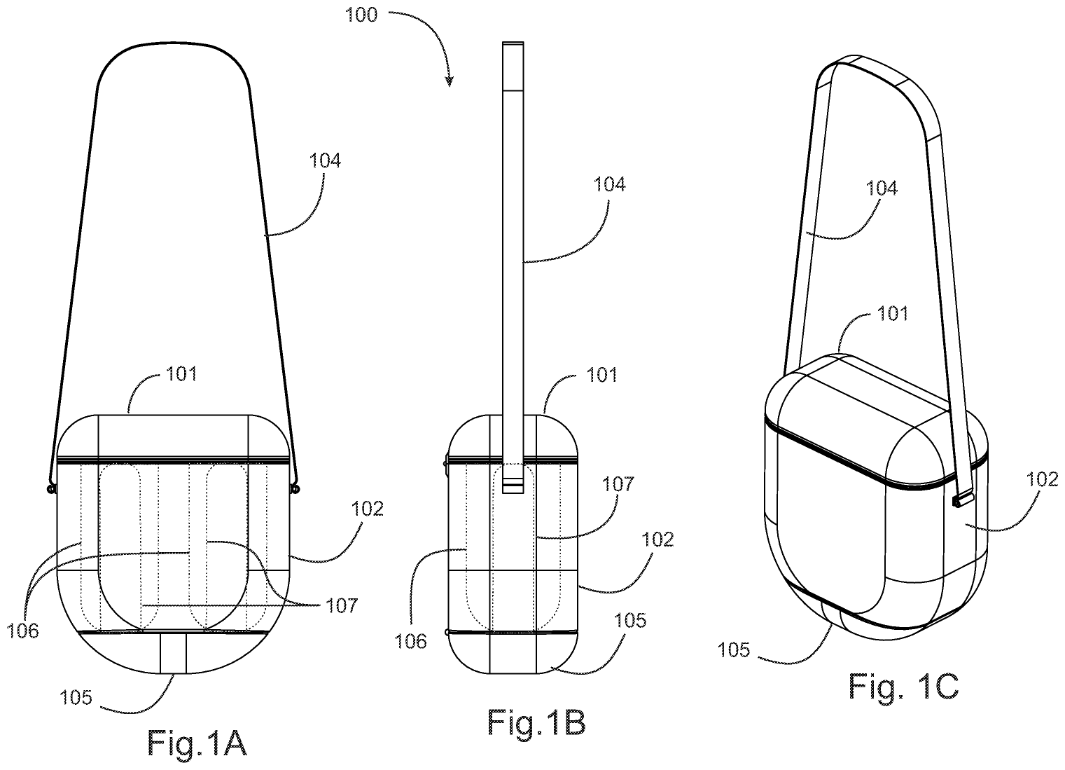

FIG. 1A is a front elevation view of an airflow boxing glove case according to an embodiment of the present invention. FIG. 1B is a side elevation view of the airflow boxing glove case of FIG. 1A. FIG. 1C is a perspective view of the airflow boxing glove case of FIG. 1A. Referring now to FIG. 1A, in one embodiment of the present invention, a boxing glove enclosure 100 is provided for the purpose of storing, transporting, and drying a pair of boxing gloves.

In this embodiment, airflow glove case 100 includes a case top 101 that may be opened and closed and a case bottom 105 that may also be opened and closed. Airflow boxing glove case 100 includes a main body 102 having a sufficient internal volume to store a pair of boxing gloves in an upright (vertical) position. Referring to FIG. 1C, airflow boxing glove case may include a strap handle 104 (visible in all three views), that may enable the case to be transported as a satchel or purse carried over one's shoulder.

Airflow boxing glove case 100 may be molded from a polyvinyl chloride (PVC) or other plastic or rubber composites. In one embodiment, case 100 is resilient and holds a rigid to semi-rigid form, however that should not be construed as a limitation of the invention. In one embodiment, airflow boxing glove case 100 may be fabricated from a more pliable synthetic material such as a material used to fabricate a stiff bag or purse without departing from the spirit and scope of the invention.

Referring again to FIG. 1C in perspective, airflow boxing glove case 100 is molded in the form of a rounded rectangle having both rounded corners and edges. The form has an internal depth dimension sufficient for enclosing the length of a pair of boxing gloves inserted vertically into designated pockets 106 (FIG. 1B). The form has an internal width dimension sufficient to enclose two vertically oriented boxing gloves adjacent to one another in linear relationship.

In one embodiment, a further airflow internal apparatus in the form of airflow devices or manifolds 107 (broken boundaries) is provided to direct airflow from the outside of the case structure or at least from the outside of the internal molded form into each stationed boxing glove within the case structure. In this vertically oriented embodiment, an internal molded form including the pair of oblong pocket forms 106 may be provided wherein the pair of airflow devices, typically manifolds 107 may be stationed vertically within each pocket form (one manifold per pocket form) the manifolds extending into the boxing gloves and keeping the gloves centered in a vertical position within each pocket form.

Although not illustrated in this view, a pair of small electronic fans may be provided at the base of each manifold 107 at the lower portions of the molded pocket forms 106 to force airflow directly into the gloves through openings placed through the manifold's wall. Such components might be powered by a rechargeable battery and might be switched on and off by an electric switch operated by a user. A charge port may be provided for charging the pair of fans within airflow boxing glove case 100. In a preferred embodiment, pocket forms 106 are open at the top and the tops of the boxing gloves may extend into the rounded case top 101 having sufficient internal volume to close over the top ends of the boxing gloves.

Referring now to FIG. 1B, case top 101 and case bottom 105 are hinged at the left side in this view using standard hinge plate hardware. Referring now to FIG. 1C, airflow case 100 may include one or more openings placed through the case wall to allow air to flow into the boxing glove case, however that is not required to practice the invention. In one embodiment, the internal molded form, including oblong pocket forms 106 and airflow manifolds 107 have strategically placed airflow openings through the walls thereof that may take various forms without departing from the spirit and scope of the present invention. Such forms may include elongate through slots, circular openings, or the like arranged in a pattern or patterns distributed over the mold form inside the main body 102, distributed over the area of the manifolds, and or distributed within the oblong pocket forms provided in the internal mold form to station the boxing gloves for drying.

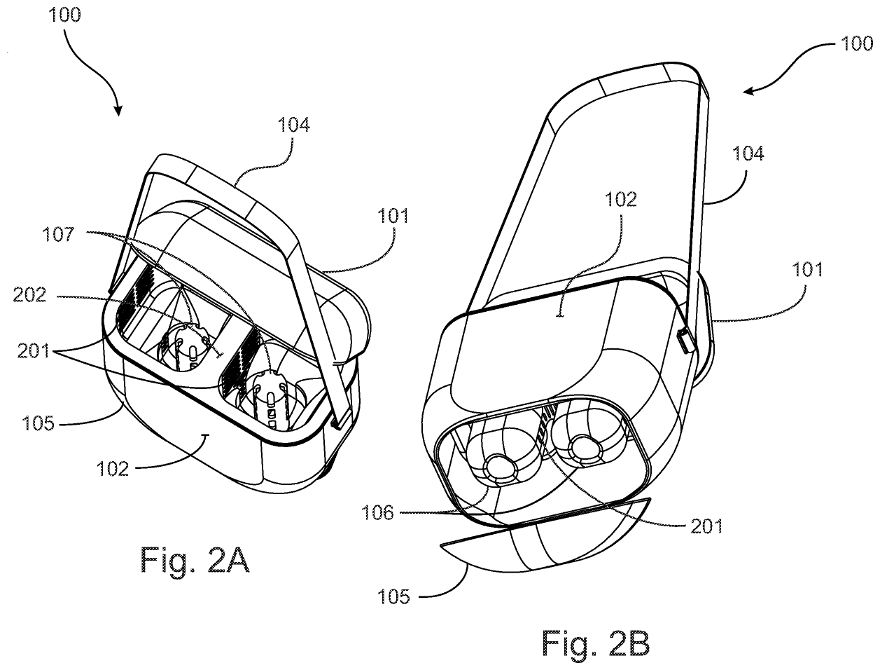

FIG. 2A is an overhead perspective view of airflow boxing glove case 100 of FIG. 1A depicting interior elements. FIG. 2B is an underside perspective view of airflow boxing glove case 100 of FIG. 2A. Referring now to FIG. 2A, boxing glove case 100 is viewed from above with case top 101 opened slightly. In one embodiment, strap 104 is modular and can be removed from and attached to mounting positions on case main body 102 to be used as an over-the-shoulder strap for carrying case 100. Strap 104 may be a polyvinyl strap, a leather strap, or a fabric strap without departing from the spirit and scope of the present invention.

In this embodiment, an internal molded plastic form 202 is provided and may be fitted to the inside of case main body 102. Referring now to FIG. 2B, plastic form 202 contains the oblong pocket forms 106. Referring now back to FIG. 2A, manifolds 107 are stationed vertically roughly center within oblong pocket forms 106 and may be a contiguous form of the main internal form 202 or may be a separate part that is attached at the bottom center of each pocket form. Manifolds 107 have an overall length to extend from the base of pocket form 106 the full height of main body 102 and into the rounded bottom of case top 101. In general application, the boxing gloves are placed one per over the manifolds rising from the pocket forms, the open ends of the gloves facing downward.

Manifolds 107 may in one embodiment, include strategically placed slots or openings through the manifold wall to enable airflow to be directed from inside the manifold and to the internal space of the boxing glove from the glove opening to the closed end at top of the airflow case. In a preferred embodiment, airflow is directed to the manifolds and upward into the glove and back out through the glove providing a constant movement of air around all parts of the inside space of the glove aiding in drying the glove by picking up moisture and carrying it out of the glove.

In this embodiment, case 100 includes no vents that are visible. The airflow vents 201 are strategically placed in the main mold form 202 fitted into case 100. However, in certain embodiments, one or more airflow vents may also be placed through the outer case body or through the case bottom or case top without departing from the spirit and scope of the present invention. In one embodiment of the invention, the airflow case may include airflow passages provided there through the main case body 102, in the case top 101 or in the case bottom 105, or in all or a combination thereof while the main mold form 202 does not contain airflow passages other than at the base of the manifolds 107.

In one embodiment, a pair of small electric fans (not illustrated) may be installed one fan at the base of each manifold 107. In this case, the fans are provided to force movement of air in an upward direction through each manifold. A battery and switch may be provided in the mold form 202 or on the main body 102 of airflow case 100 to power and control the electric fans. A charging port may also be provided in the side of case 100 that may accept charge from an outlet or from a universal serial bus (USB) connection. Referring now to FIG. 2B, in one embodiment, slots or openings 201 are placed through the mold form breaking into oblong pockets 106 allowing air to pass freely through the molded pockets beneath the upper surface of the main molded form 202.

In a preferred embodiment, a user may take off the boxing gloves after a bout or during a training break and open case top 101 of airflow case 100 and insert each glove into respective pocket forms 106 over manifolds 107 (staged vertically) and may close case top 101. The user may then switch the fan system on manually operating a switch on the case provided for the purpose. While on, airflow is created within airflow case 100 by the fans drawing air up and into the manifolds embedded within each glove, respectively.

The air constantly moves into the boxing gloves and back out of the boxing gloves helping to dry the boxing gloves out by removing moisture from the gloves. In one embodiment, a timer function may be added to the on off switch to enable the user to switch the fans on for a selected period of time to allow for drying the gloves. In a preferred embodiment, airflow boxing glove case 100 is modular and may be operated by battery power in places where no outlet or charging source is available.

In a further embodiment of the present invention, a pair of electric heating elements insulated from the rest of the case components may be provided just below the electric fans for the purpose of heating the air drawn into the boxing gloves through the manifolds. Also in one embodiment, a super absorbent material like bamboo fiber may be provided and may be situated strategically over vents or around the base regions of the manifolds to absorb some of the moisture carried in the circulating air.

In one embodiment, internal molded form 202 may be removed from main case body 102 for cleaning purposes. Case bottom 105 may be opened to allow access to a battery compartment and to enable access to the bottom portion of the internal molded form 202 for cleaning while it is still installed within main case body 102. In one embodiment, case top 101 and case bottom 105 may be completely removed from main case body 102 and reinstalled.

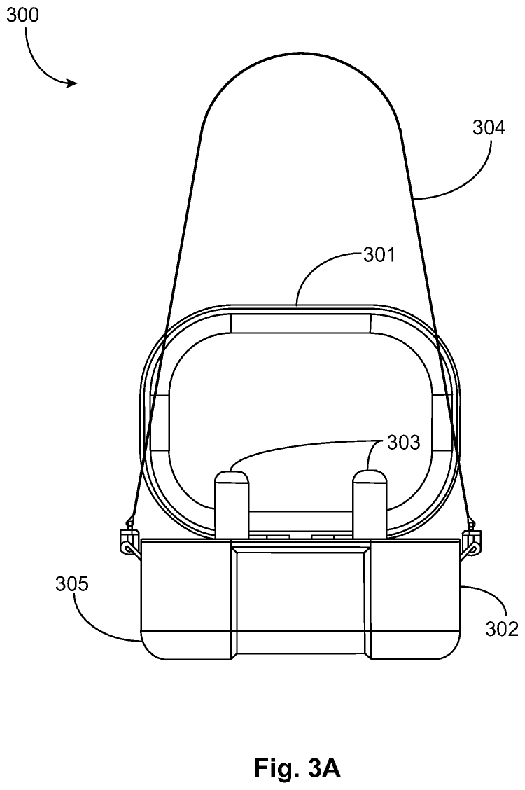

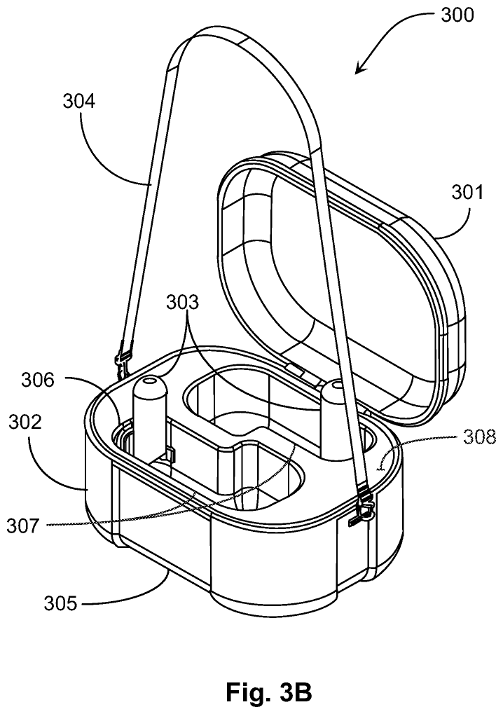

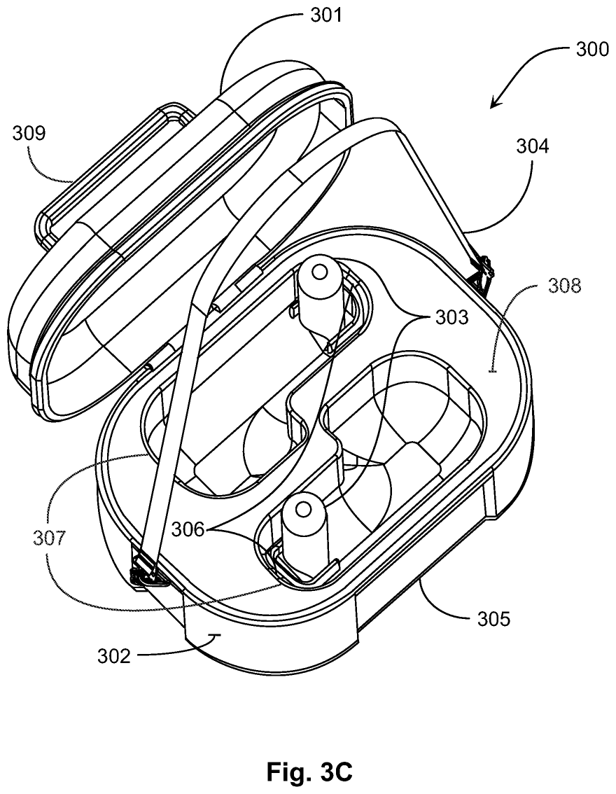

FIG. 3A is a front elevation view of an airflow boxing glove case 300 according to another embodiment of the present invention. FIG. 3B is a perspective view of airflow boxing glove case 300 of FIG. 3A depicting interior elements. FIG. 3C is an overhead perspective view of airflow boxing glove case 300 of FIG. 3A depicting interior elements.

Referring now to FIG. 3A, an airflow boxing glove case 300 is provided having a main case body 302, a case top 301, and a case bottom 305. In this embodiment, case 300 is modified to enclose two inserted boxing gloves that are positioned laterally within the airflow case. Airflow boxing glove case 300 may include a shoulder carry strap 304 analogous to strap 104 described further above with respect to airflow case 100.

Airflow boxing glove case 300 includes a pair of airflow manifolds 303 depicted in a vertical position ready to accept a pair of boxing gloves. Manifolds 303 may be similar to manifolds 107 relative to tubular architecture and overall length. In this embodiment, a modification is made to the manifold components whereby the base portions of each manifold may be axle mounted to the base ends of lateral oblong pocket forms (not visible) molded into the main mold form installed within the case main body 302.

Referring now to FIG. 3B, airflow case 300 is in the form of a rounded rectangle like case 100 but is orientated laterally having a greater length and width and a smaller height. In this embodiment, an internal molded form 308 including a pair of molded pocket forms 307 is provided and may be fitted or otherwise installed within main case body 302 analogous to the embodiment of case 100 relative to molded form 202 and main case body 102. Molded pocket forms 307 are shaped to nest boxing gloves that are first placed over manifolds 303 and then urged downward to nest laterally in the pocket forms 307 with the aid of the pivot mounting apparatus provided at the base of each manifold 303 enabling each manifold to be erected vertically or pivoted to the lateral position along the center of the host pocket form.

The width dimension of case 300 is sufficiently large to accommodate the width of two boxing gloves stationed adjacently plus a separation buffer distance. Airflow case 300 is sufficiently long to comfortably enclose the length of a stationed boxing glove. Case 300 is sufficiently deep enough to comfortably contain the width of a boxing glove. In this embodiment, and in the embodiment described further above, the airflow boxing glove case may be provided in overall size dimensions appropriate with dimensional differences correlating to dimensional differences of different sized boxing gloves.

Pocket forms 307 have a wider berth along the length thereof to provide more volume for the wider padded end of the boxing glove. Pocket forms 307 are strategically oriented in mold form 308 in order to utilize the footprint of the mold form more efficiently 308. Manifolds 303 are positioned at the base ends of the pocket forms 307 and may be separate components pivot-mounted to the wall of the pocket forms. In this embodiment, an airflow vent, or vents 306 may be provided through the wall of the pocket forms 307.

In this embodiment, manifolds 303 may be void of, or may have fewer openings through the wall thereof and may direct airflow along the length of the manifold to an egress opening at the free ends of the manifolds. In other embodiments, manifolds 303 may have a plurality of slots and or openings allowing air to flow out of the interior of the manifold at those locations. Manifolds may be designed differently relative to airflow properties without departing from the spirit and scope of the present invention.

In one embodiment, an absorbent filter material may be inserted into the interior part of manifold 303 to help absorb moisture directing it into the absorbent material from the circulating air that contacts the material by circulating through the material. A user may operate case 300 differently than case 100. A user may open case 300 and may urge each manifold along a pivot to a vertical position. The user may place a boxing glove over each manifold the glove orientated according to the nesting pocket form 307. The user may then urge each glove down into the respective pocket forms and then may close case lid 301. The user may then flip a switch to power on a pair of electric fans situated at the base ends of the manifolds 303 oriented to draw air into the manifolds. In this embodiment, the fans are part of the manifolds and pivot with the manifolds.

Referring now to FIG. 3C, case top 301 includes a case handle 309 as an option for a user to carry case 300 without using strap 304. In this embodiment, airflow vents 306 are strategically located near the base of each manifold 303 through the vertical wall of the pocket form 307 to allow fresh dry air to be drawn into the manifolds from beneath and around the pocket forms inside case 300. In one embodiment, airflow vents may also be strategically placed through the main case body 302, the case top 301, and or the case bottom 305. The main objective of the present invention is that an airflow may be directed into and out of the stationed boxing gloves.

Referring now to FIG. 3A, a user may station boxing gloves over manifolds 303 and leave the boxing gloves stationed vertically over the manifolds with case top 301 open to dry the insides of the boxing gloves in an upright position. In each of the described embodiments, the boxing gloves are stationed over the respective manifolds to enable circulated airflow to reach all of the inside space of the boxing gloves.

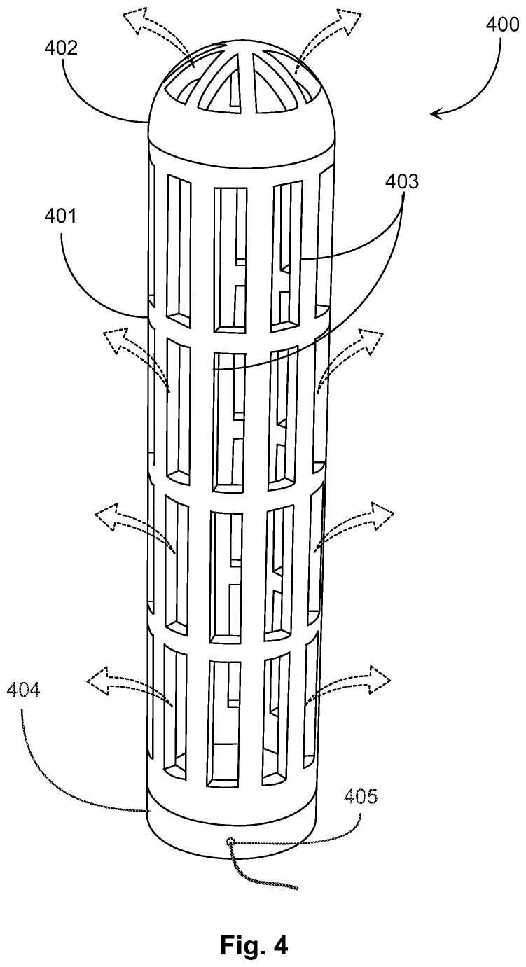

FIG. 4 is a perspective view of an airflow device 400 used in an airflow boxing glove case according to one embodiment of the invention. Airflow device 400 may be analogous in one embodiment with airflow device 107 described further above with reference to FIG. 2A. Airflow device 400 may be referred to herein as a manifold 400 given the structural properties thereof. In this embodiment, manifold 400 includes a removable cap 402 that may be threaded onto or pressed onto the free end of the manifold tubular structure 401.

In this embodiment, manifold 400 includes a pattern of through slots 403 strategically placed through the tube wall along the length of and around the circumference of tube structure 401. Slots 403 provide airflow passages through the wall of the manifold into the interior of a boxing glove during operation, the direction of airflow noted herein by the arrows depicted in broken boundary lines. Slots or openings are also provided through the wall of end cap piece 402 taking a more triangular shape. Holes, slots, and other opening shapes and sizes including combinations of the aggregate might be provided in a manifold to help direct airflow into the boxing glove without departing from the spirit and scope of the present invention.

In this embodiment, a small electric fan 404 is provided at the bottom end of the tube structure 401 forming the main body of manifold 400. An electric wire 405 may supply electricity to the fan motor in fan component 404 and may be routed to a user-operable switch and battery located in the main case wall of the airflow boxing glove case or in the internal mold form inside the case.

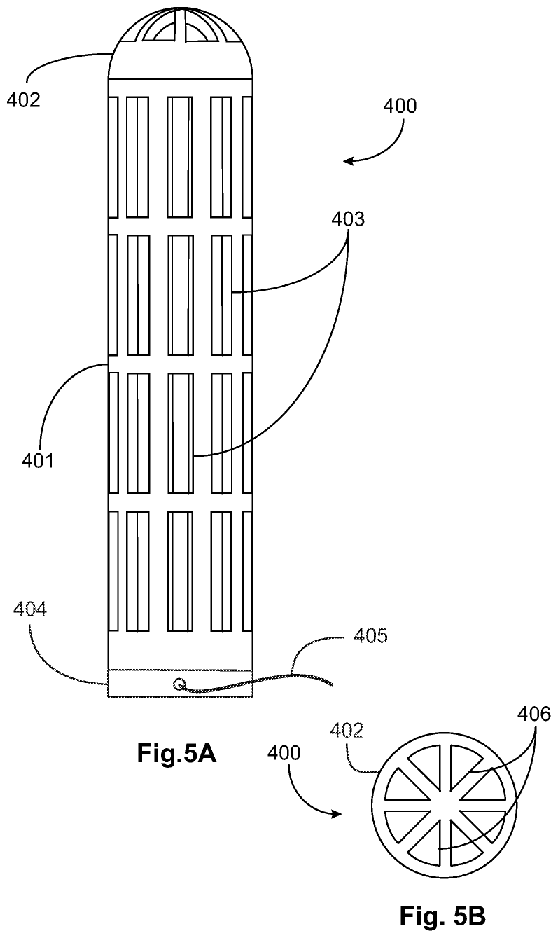

FIG. 5A is a side elevation view of airflow device 400 of FIG. 4. FIG. 5B is a top end view of manifold 400 of FIG. 4. Referring now to FIG. 5A, manifold 400 may be an assembly that is fabricated separately from the main mold form of the airflow case. In this embodiment, manifold 400 includes end cap 402, a manifold tube structure 401, an electric fan 404, and a wire 405 to supply power. Slots 403 are strategically oriented vertically and equally spaced about the circumference of tube structure 401.

Referring now to FIG. 5B, end cap 402 may contain slots or openings like or similar to slots 403 or in this case triangular openings 406 provided in an equal spaced pattern around the circumference of the end cap. Fan 404 and power supply wire 405 are removed from this view. In this embodiment, manifold 400 is adapted for the vertical embodiment of the airflow boxing glove case described with reference to FIGS. 1A-1C and 2A-2B.

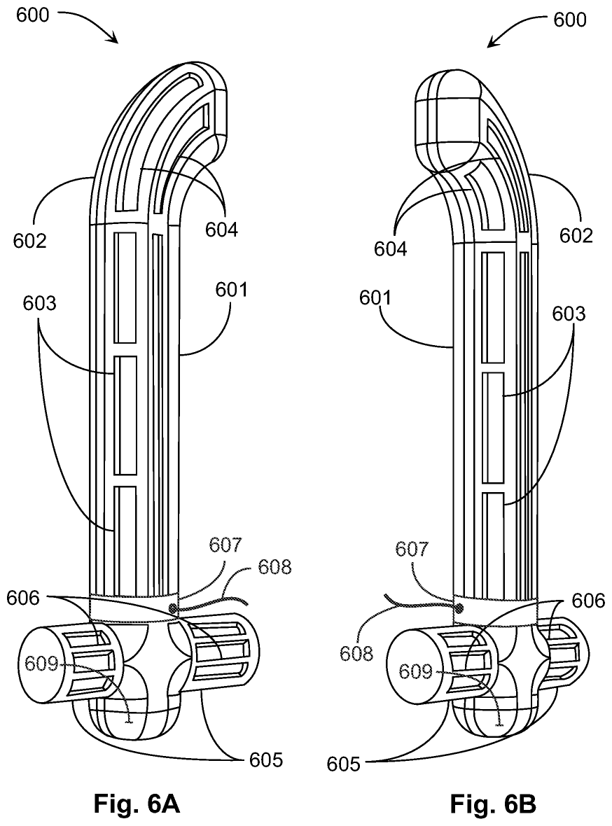

FIG. 6A is a perspective view of an airflow device 600 used in an airflow boxing glove case according to one embodiment of the invention. FIG. 6B is a perspective view of the airflow device of FIG. 6A rotated to an opposing 180 degrees for reference. Referring now to FIG. 6A, airflow device 600 may be a manifold device and maybe referred to herein as manifold 600. In a preferred embodiment, a pair of manifolds 600 are utilized in an embodiment where the boxing gloves are stationed laterally in the airflow boxing glove case as in the embodiment relative to the description of FIGS. 3A through 3C. Manifold 600 may have a tubular structure 601 that is capped at both ends. In this embodiment, manifold 600 includes an end cap 602 attached to the top end of tube structure 601, and a base cap attached to the base end of tube structure 601.

In this embodiment, manifold 600 is curved inward beginning at the interface between tube 601 and end cap 602 relative to the curvature of the top end of a boxing glove. In this embodiment manifold 600 is shaped to conform with the shape of the interior of the boxing glove. The curve may be an arc from zero degrees horizontal to about ninety degrees vertical. The curvature helps to direct airflow off to one direction representing the first form at the closed end of the boxing glove.

Manifold 600 may include a pair of vent caps 605 that attach linearly on opposite sides of tube structure 601 some distance above base end cap 609. In one embodiment, vent caps 605 form the pivotal mount apparatus attaching the manifold to the pocket form that it is designed to nest within. Vent caps 605 may be slotted according to a pattern of slots 606. A small electric fan 607 is provided and installed on the lower portion of tube structure 601 above the vertical plane of the vent caps 605.

Vent caps 605 share a longitudinal center line orthogonal to the center line of tube structure 601. Power line 608 may be routed to a switch and battery located on the case body or on the molded main form within the case body. Electric fan 607 is adapted to draw air into the tube structure and into the boxing glove creating a circulating airflow draw into and back out of the boxing glove. In this embodiment, manifold 600 nests in a laterally oriented pocket form that is shaped like the boxing glove profile has sufficient volume to station the glove laterally. In one embodiment, manifolds 600 may be left vertical relative to the pocket forms with the case top open wherein boxing gloves may be dried while stationed over the manifolds but not nested in a pocket form.

In this embodiment tube structure 601 includes a slot pattern of elongate slots 603. Slots 603 may continue as curved slots 604 on end cap 602. In one embodiment the airflow pattern for the manifold may include shorter or longer slots, wider or thinner slots, openings that are annular, or openings of a geometric shape other than round or rectangular without departing from the spirit and scope of the present invention. In one embodiment, the vent caps may be opened, and moisture absorbent air filter material may be inserted therein at both ends to aid in absorbing moisture from the air being drawn into fan 607. In one embodiment, such filters may also be treated with one or more chemicals that reduce microbes, fungus, and mold. In one embodiment of the present invention, the main molded forms inside of the case bodies may be coated with a moisture repelling material similar to hatbox felt material, beaver hair, or another natural moisture repellant material.

It will be apparent with skill in the art that the airflow boxing glove case of the present invention may be provided using some or all the elements described herein. The arrangement of elements and functionality thereof relative to the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. An enclosure for drying items worn during exercise, comprising:
a hollow case body having an internal volume, a case top closing one end, and a case bottom closing the other end of the hollow body;
a main mold form having perimeter dimensions conforming to the internal perimeter of the hollow case body fitted or otherwise installed therein, the mold form including a pair of oblong pocket forms having sufficient internal volume to nest a pair of items;
a pair of airflow devices electronically equipped to generate directional air circulation into and out through a tubular architecture, one airflow device strategically mounted within one pocket form;
wherein one each of the items are placed over each of the airflow devices and urged to nest within the pocket forms in the main mold form, and wherein a switch connected to a power source is manipulated by a user to power on the airflow devices to circulate air through the case and through an internal volume of the items.

2. The enclosure of claim 1, wherein the items are gloves, including boxing gloves.

3. The enclosure of claim 1, wherein the case top and case bottom are pivot mounted to one side of the hollow case body and may be opened or closed.

4. The enclosure of claim 1, wherein the case top and case bottom are attachable to close off the hollow case body, and removable to open the hollow case body.

5. The enclosure of claim 1, wherein the oblong pocket forms are contiguous with the main mold form and arranged linearly and oriented vertically within the enclosure.

6. The enclosure of claim 1, wherein the oblong pocket forms are contiguous with the main mold form and arranged adjacently and oriented horizontally.

7. The enclosure of claim 6, wherein the oblong pocket forms retain the general shape of a boxing glove.

8. The enclosure of claim 1, wherein the airflow devices are manifolds electrically adapted to generate directional air circulation by a pair resident electric fans installed one each in the manifolds, the fans having electrical connection to the battery and the switch, the battery having a further electrical connection to a charging port mounted on the hollow case body or on the main mold form within the hollow case body.

9. The enclosure of claim 8, wherein the manifolds are rigidly attached to or are materially contiguous with the oblong pocket forms the manifolds and pocket forms oriented vertically within the enclosure, the manifolds each hosting a glove placed thereon, the glove nesting within the oblong pocket form.

10. The enclosure of claim 8, wherein the manifolds are separate components pivot-mounted to the oblong pocket forms, the manifolds urged to vertical position to accept the items and pivoted to horizontal to nest within the oblong pocket forms.

11. The enclosure of claim 1, wherein the main mold form includes one or more strategically placed airflow slot patterns or patterns of openings enabling airflow through the main mold form and into the airflow devices.

12. The enclosure of claim 10 wherein the manifolds include a pair of opposing vent caps disposed at either side of the manifold body and oriented orthogonal to the longitudinal center of the manifold.

13. The enclosure of claim 8, wherein the manifolds include removable end caps threaded onto or pressed onto the free ends thereof.

14. The enclosure of claim 8 further including one or more airflow filters formed of a moisture absorbing material placed in the path of airflow circulation.

15. The enclosure of claim 8 further including a pair of heating elements disposed one per to the manifolds just above or below the electric fans.

16. The enclosure of claim 8, further including a timer function connected to the switch.

17. A method for staging and drying a pair of items within an enclosure including a hollow case body having a case top and a case bottom hosting a main mold form having perimeter dimensions conforming to the internal perimeter of the hollow case body, the mold form including a pair of oblong pocket forms each hosting an airflow device electronically equipped to generate air circulation, including steps:
(a) opening the case top to gain access to the main mold form;
(b) place one glove over one airflow device nested within a host pocket form;
(c) place the remaining glove over the remaining airflow device nested within the remaining pocket form;
(d) engaging a switch to power on the airflow devices; and
(e) optionally closing the case top.

18. The method of claim 17, wherein the airflow devices are manifolds equipped with electrical fans for circulating air.

19. The method of claim 18, wherein a step is added after step (a) and before step (b) for urging horizontally positioned manifolds into a vertical position to accept the items placement there over, and wherein a step is added after (c) and before (d) for urging the manifolds hosting items back down into a horizontal position within the pocket forms.

20. The method of claim 19, wherein the step added after (c) and before (d) is optional wherein if not implemented, step (e) cannot be implemented.
